(19) United States
(12) Patent Application Publication
(10) Pub. No.: US 2023/0241756 A1
(43) Pub. Date: Aug. 3, 2023

(54) Handheld work apparatus

(71) Applicant: Andreas Stihl AG & Co. KG, Waiblingen (DE)

(72) Inventor: Markus Nefzger, Winnenden (DE)

(73) Assignee: Andreas Stihl AG & Co. KG, Waiblingen (DE)

(21) Appl. No.: 18/159,791

(22) Filed: Jan. 26, 2023

(30) Foreign Application Priority Data
Jan. 28, 2022 (EP) 22154068.5

(51) Int. Cl. B25F 5/02; H05B 3/34

(52) U.S. Cl. CPC B25F 5/02; H05B 3/34; B27B 17/0008

(57) ABSTRACT

The invention relates to a hand-carried work apparatus with a housing (2), with a drive motor (3) arranged in the housing (2), wherein the drive motor (3) drives a tool (5) arranged at the front end (30) of the housing (2), wherein a first electrical functional element (13) is arranged in the housing (2), and wherein at least one second electrical functional element (14) is arranged on the outside (12) of the front handle (6), wherein the first electrical functional element (13) is connected to the second functional element (14) via at least one connecting cable (15), and wherein the at least one connecting cable (15) is arranged at least partially in the interior space (10) of the front handle (6) in the area of the side section (33) of the front handle (6).

### CROSS-REFERENCE TO RELATED APPLICATION

This application claims the benefit of European Patent Application No. 22154068.5, filed 28 Jan. 2022, the contents of which are incorporated by reference in their entireties.

### TECHNICAL FIELD

The disclosure relates to a hand-carried work apparatus such as a portable power tool.

### BACKGROUND

Hand-carried work apparatuses, such as a motor chain saw, a hedge trimmer, or the like are known, which are usually used outdoors. A hand-carried work apparatus is to be understood as referring to a work apparatus that is in particular being carried by the operator during intended use. At particularly low temperatures, the handles of the work apparatus are cold. In order to heat the handles, the use of handle heaters is known. A handle heater can be designed as an electric handle heater, which is connected to a generator or a battery of the work apparatus.

### SUMMARY

It has been found that handle heaters of hand-carried work apparatuses often no longer function after a certain time of operation of the work apparatuses.

The invention is therefore based on the object of specifying a hand-carried work apparatus which enables reliable operation of an electrical functional element arranged on a handle of the work apparatus.

This object is achieved by a hand-carried work apparatus as claimed.

The inventors recognized that the defect of the above-described functional element that is arranged on the handle, such as a handle heater, that occurs during operation of the work apparatus can often be traced back to a cable break in the connecting cable. The connecting cable between the handle heater and the power source for the handle heater runs on the outside of the handle tube and is covered by a handle cover. When using the work apparatus, branches from bushes, shrubs or trees, among other things, can brush against the handle and damage the handle cover and the connecting cable.

The improved hand-carried work apparatus comprises a housing. The housing has a top side, a bottom side, a first longitudinal side, and a second longitudinal side. The top side and the bottom side are connected to one another via the first longitudinal side and via the second longitudinal side. The hand-carried work apparatus comprises a drive motor arranged in the housing. The drive motor drives a tool arranged at the front end of the housing. The hand-carried work apparatus comprises a front handle and a rear handle. The front handle is designed as a handlebar and has a transverse section extending along the top side of the housing and a side section extending along one of the two longitudinal sides of the housing. The front handle has a wall and an interior space enclosed by the wall. The wall of the front handle comprises an inside facing the interior space and an outside facing away from the interior space. A first electrical functional element is arranged in the housing. At least one second electrical functional element is arranged on the outside of the front handle. The first electrical functional element is connected to the second functional element via at least one connecting cable. The at least one connecting cable is arranged at least partially in the interior space of the front handle in the area of the side section of the front handle.

The connecting cable lies at least partially in the interior space of the side section of the front handle and is thus protected by the front handle. Branches or the like can thus touch the front handle of the work apparatus on the side section without damaging the connecting cable. Reliable operation of the second electrical functional element is thereby ensured.

The second electrical functional element is preferably designed as a heating foil. In an alternative configuration, the second electrical functional element can also be designed as a sensor.

The first electrical functional element is preferably an energy source for supplying the second functional element with electrical current. The energy source is preferably a generator. Alternatively, the energy source can also be a battery. Alternatively, the first electrical functional element can also be a control unit for processing data signals. The control unit is supplied with electrical current via an energy source.

An opening is advantageously provided on the wall of the front handle, in particular adjacent to the second electrical functional element. The opening extends from the outside of the wall to the inside of the wall. The at least one connecting cable runs from the outside of the wall through the opening into the interior space of the handle. The opening is preferably provided with a grommet as edge protection. The grommet is preferably formed from an elastomer. This avoids chafing of the connecting cable at the opening.

It is preferably provided that the front handle has an approximately horizontally extending holding section, wherein the opening of the wall is provided outside the holding section. The horizontally extending holding section is provided for holding the work apparatus during normal operation of the work apparatus. Accordingly, the horizontally extending holding section is the area of the front handle which is most frequently gripped by the operator. If the opening were provided on the horizontally extending holding section, then the operator would feel it. The operator might perceive the opening as unpleasant from an ergonomic point of view. In order to avoid this circumstance, the opening is provided outside the horizontally extending section.

It is preferably provided that the transverse section and the side section of the front handle are connected to one another via a curved connecting section, wherein the opening is provided in the side section adjacent to the connecting section. An opening in the horizontally extending section of the front handle is to be avoided for reasons already described above. Furthermore, the opening should also not be formed in the curved connecting section. An opening in the curvature would be disadvantageous for reasons of the high stress conditions and the associated weakening of the strength of the front handle. Furthermore, the connecting cable should be protected as much as possible by the front handle. Therefore, the opening is to be provided in the side section preferably directly adjacent to the curvature section of the front handle. The handle is preferably made of aluminum or plastic.

In particular, it is provided that the work apparatus comprises a handle tube insert for fastening the front handle to the housing of the work apparatus. The handle tube insert is arranged in the interior space of the handle at one end of the front handle. The handle tube insert has a cable channel for guiding the at least one connecting cable. During assembly of the work apparatus, the handle tube insert can be inserted into the front handle, and the connecting cable be guided in the cable channel. It can so be avoided that the connecting cable becomes jammed between the handle tube insert and the handle. The handle tube insert has a cable fixation for clamping the at least one connecting cable. Thus, if the handle tube insert is almost completely inserted into the front handle, the connecting cable can be fixed in the cable fixation. Thereby, the length of the section of the connecting cable which is provided in the front handle can be specifically adjusted. Also, the connection point of the connecting cable to the second functional element is relieved by the clamping on the handle tube insert. In particular during assembly of the work apparatus, the connecting cable can be subject to tensile load. As a result of the clamping of the connecting cable, the tensile load is already absorbed at the clamping point of the connecting cable. The connection of the connecting cable and of the second electrical functional element remains undamaged.

It is advantageously provided that the connecting cable runs from the outside of the wall of the front handle via the interior space of the front handle through the connecting channel of the handle tube insert to the one end of the front handle. Thus, the connecting cable lies protected from external loads to a large extent in the front handle.

Further features of the invention will become apparent from the description and the drawing. An exemplary embodiment is described in detail below.

### BRIEF DESCRIPTION OF THE DRAWINGS

FIG. 1 shows a schematic, partial, perspective view of a motor chain saw.

FIG. 2 shows a perspective view of a front handle and an electrical functional element of the motor chain saw according to FIG. 1.

FIG. 3 shows a side view of the front handle and the electrical functional element of the motor chain saw according to FIG. 1.

FIGS. 4 to 7 show a side view of individual assembly steps with regard to the fastening of a handle tube insert with cable channel and cable fixation in the front handle of the motor chain saw according to FIG. 1.

FIG. 8 shows a schematic, partial side view of the motor chain saw according to FIG. 1.

### DETAILED DESCRIPTION

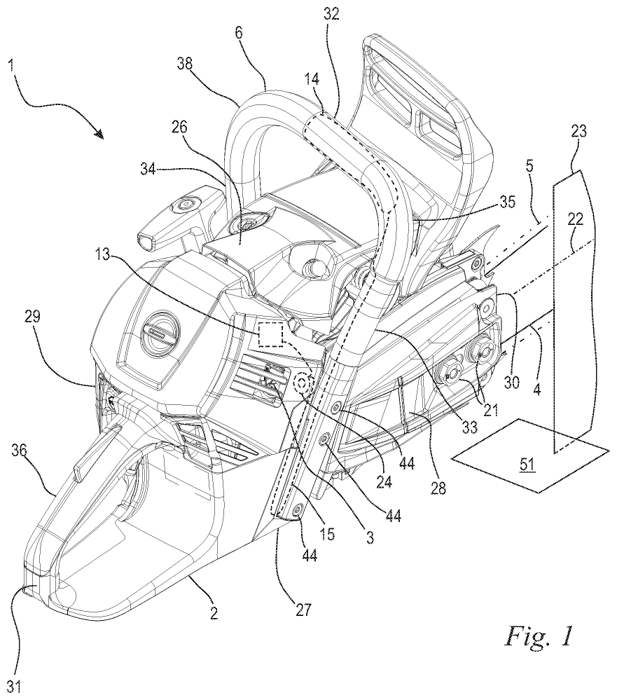

FIG. 1 shows an exemplary embodiment of a hand-carried work apparatus 1, which is designed as a “rear-handle” motor chain saw. In an alternative embodiment, the work apparatus 1 can also be a “top-handle” motor chain saw. The work apparatus can also be designed as a hedge trimmer, cut-off grinder, blower, brush cutter, or the like. The work apparatus 1 comprises a housing 2, and a drive motor 3 arranged in the housing 2. In the preferred exemplary embodiment, the drive motor 3 is designed as an internal combustion engine. In an alternative configuration of the work apparatus 1, it can be expedient to design the drive motor 3 as an electric motor, which in turn can be supplied with energy via a rechargeable battery or via a connecting cable to a power grid.

As shown in FIG. 1, the housing 2 has a top side 26, a bottom side 27, a first longitudinal side 28 and a second longitudinal side 29. The top side 26 and the bottom side 27 are connected to one another via the two longitudinal sides 28, 29. In addition, the work apparatus 1 includes a front handle 6 and a rear handle 36. The handles 6, 36 are used to hold and guide the work apparatus 1. The rear handle 36 is formed at a rear end 31 of the housing 2. At the side of the housing 2 opposite the rear handle 36, that is to say at a front end 30 of the housing 2, a guide bar 4 projects forward. A chainsaw chain which is driven by the drive motor 3 is arranged so as to run around the guide bar 4. The chainsaw chain forms the tool 5 of the work apparatus 1.

The drive motor 3 drives a drive sprocket via a drive shaft (not shown in more detail). The drive sprocket is used to drive the chainsaw chain, which is guided over the drive sprocket during operation. Furthermore, the work apparatus 1 comprises a tensioning device 21 via which the guide bar 4 can be displaced forwards in the direction of its longitudinal axis 22 away from the drive sprocket. The longitudinal axis 22 runs centrally through the guide bar 4 approximately parallel to the horizontal ground 51 when the work apparatus 1 is placed on a level horizontal ground 51. The term “approximately” is to be understood in such a way that the longitudinal axis 22 of the guide bar 4 encloses an angle of at most 15° with the ground 51. The guide bar 4 has a longitudinal plane 23 which contains the longitudinal axis 22 and is perpendicular to the ground 51 when the work apparatus 1 is placed on a level horizontal ground 51.

In the exemplary embodiment, the front handle 6 is designed as a handlebar. The front handle 6 is formed from a handle tube. The front handle 6 is preferably made of aluminum or plastic. The front handle 6 has a transverse section 32 extending along the top side 26 of the housing 2, a side section 33 extending along the first longitudinal side 28, and a further side section 34 extending along the second longitudinal side 29. The front handle 6 is fastened to the housing 2 at the respective ends. The end of the first longitudinal side 28 of the front handle 6 is fastened to the side section 33 of the housing 2. The other end of the front handle 6 is fastened to the bottom side 27 of the housing 2.

As shown in FIG. 1, a merely schematically illustrated electrical functional element 13 is arranged in the housing 2. In the exemplary embodiment, the electrical functional element 13 is designed as a control unit. The control unit is designed to process information and to control various components of the work apparatus 1, such as the drive motor 3. In the exemplary embodiment, the control unit is supplied with electrical current via a generator provided on the drive motor 3.

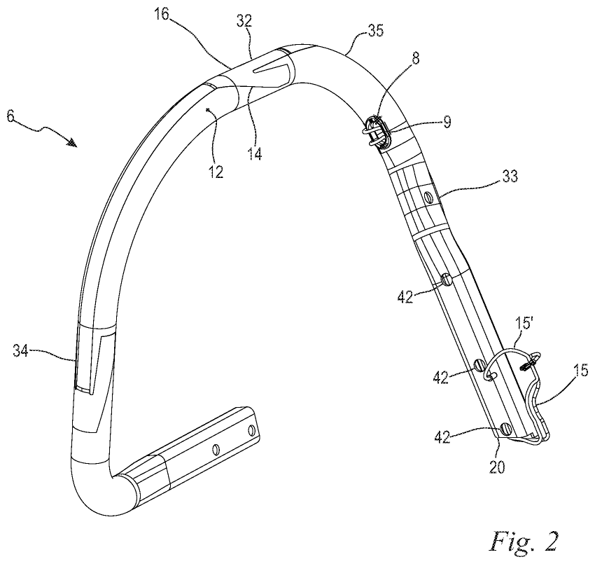

As shown in FIGS. 1 and 2, a second electrical functional element 14 is arranged on the front handle 6. The second electrical functional element 14 is designed as a heating foil. The heating foil serves to heat the front handle 6 and thus forms a handle heater. In an alternative configuration of the work apparatus, the second electrical functional element 14 can also be designed as a sensor. The sensor is preferably designed to detect whether the front handle 6 is gripped by the operator. The sensor is preferably a capacitive sensor. In an alternative embodiment of the work apparatus 1, it can also be expedient to provide several electrical functional elements on the front handle 6. Accordingly, the second electrical functional element 14 can be embodied as a heating foil and a third electrical functional element can be embodied as a sensor. The front handle 6 also preferably includes a cover 38. The cover 38 encases in particular a holding section 16 of the front handle 6. The cover 38 is made of a plastic, in particular an elastomer, and serves to fix the second electrical functional element 14 on the front handle 6. Furthermore, the cover 38 offers the operator a better, more comfortable hold on the front handle 6.

As shown in FIGS. 1 and 2, the work apparatus 1 comprises at least one connecting cable 15, wherein the connecting cable 15 connects the first electrical functional element 13 and the second electrical functional element 14 to one another. The term “connecting cable” is not limited to a single cable, but also includes multiple cables. Preferably, the cables are cables connected to one another in series. As shown in FIG. 2, the work apparatus 1 includes a further connecting cable 15′ in addition to the at least one connecting cable 15. In the exemplary embodiment, the at least one connecting cable 15 is a first conductor, and the second connecting cable 15′ is a second conductor. In the exemplary embodiment, the at least one connecting cable 15 runs from the second electrical functional element 14, which is designed as a heating foil, to the first electrical functional element 13, the control unit.

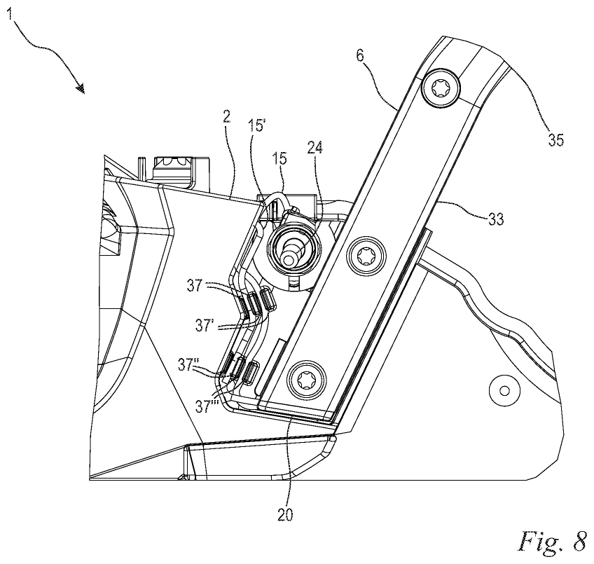

In the exemplary embodiment, a switch 24 (see also FIG. 8) is interposed between the first electrical functional element 13 and the second functional element 14. The second connecting cable 15′ is directly connected to the first electrical functional element 13. If the switch 24 is activated, the circuit is closed and the second electrical functional element 14 can be supplied with current. If the switch 24 is deactivated, the current supply is cut off.

In an alternative embodiment of the work apparatus 1, it can be expedient to provide the generator as the first electrical functional element 13. The generator is preferably an alternating voltage generator. Accordingly, the second electrical functional element 14 would be connected to the generator via the connecting cable 15. A rectifier is preferably provided between the generator and the second electrical functional element 14.

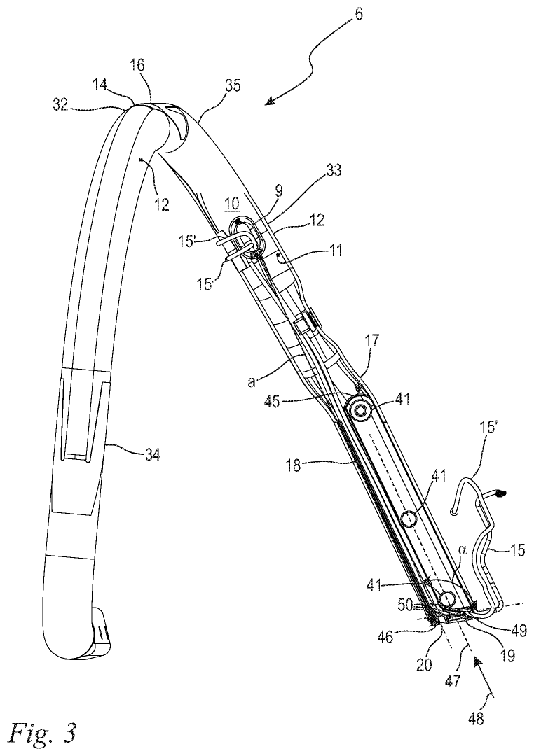

As shown in FIGS. 2 and 3, the second electrical functional element 14 is arranged on an outside 12 of the front handle 6. The connecting cables 15, 15′ run from the second functional element 14 via an opening 8 on the front handle 6 into an interior space 10 of the front handle 6. The front handle 6 has a wall 7, the wall 7 enclosing the interior space 10 of the front handle 6. Accordingly, the wall 7 of the front handle 6 comprises an inside 11 facing the interior space 10 and an outside 12 facing away from the interior space 10. The opening 8 extends from the outside 12 of the wall 7 to the inside 11 of the wall 7.

As shown in FIGS. 2 and 3, the second electrical functional element 14 is arranged on a holding section 16 of the front handle 6 which runs approximately horizontally. The holding section 16 is formed on the transverse section 32 of the front handle 6. The holding section 16 is the area of the front handle 6 by which the operator preferably grips the work apparatus 1 in an intended use position of the work apparatus. Furthermore, the second electrical functional element 14 extends over the transverse section 32 to the further longitudinal section 34 of the front handle 6. In an alternative exemplary embodiment, it may be expedient for the second electrical functional element 14 to extend from the further longitudinal section 34 via the transverse section 32 to the longitudinal section 33.

As shown in FIGS. 2 and 3, the opening 8 is formed on the side section 33 of the front handle 6. The opening 8 is formed on a side of the front handle 6 facing the housing 2. The opening 8 and the connecting cables 15, 15′ running at the opening 8 are thus protected from branches, undergrowth or other objects which can come into contact with the front handle 6 when the work apparatus 1 is in operation. As shown in particular in FIG. 2, the opening 8 is arranged outside the holding section 16. Thus, from an ergonomic point of view, the opening 8 does not disturb the operator when gripping around the holding section 16. In the preferred exemplary embodiment, the opening 8 is arranged on the side section 33 directly adjacent to a connecting section 35 of the front handle 6. The connecting section 35 is curved and connects the transverse section 32 and the side section 33 of the front handle 6. In other words, the opening 8 is located directly below the connecting section 35. The opening 8 is preferably provided outside the connecting section 35 for reasons of strength and easier manufacture of the front handle 6. Of course, in an alternative embodiment of the work apparatus 1, it can also be expedient to provide the opening 8 in the connecting section 35. Furthermore, the opening 8 is possibly fixed “at the top” on the side section 33, that is to say adjacent to the connecting section 35, in order to be able to guide the connecting cables 15, 15′ in a protected manner over a widest possible area in the front handle 6.

The connections (not shown in detail) of the second electrical functional element 14 for the connecting cables 15, 15′ are arranged in the preferred exemplary embodiment on the outside 12 in the connecting section 35. It may also be expedient for the connections of the second electrical functional element 14 to the connecting cables 15, 15′ to be arranged on the outside 12 in the transverse section 32 of the front handle 6. The connecting cables 15, 15′ run on the outside 12 of the front handle 6, starting from the connecting section 35 via the opening 8 into the interior space 10 of the front handle 6. A grommet 9 is provided at the opening 8. The grommet 9 forms an edge protection at the opening 8. This prevents damage to the connecting cables 15, 15′. The connecting cables 15, 15′ run from the interior space 10 at the opening 8 to one end 20 of the handle 6.

As shown in FIG. 8, the connecting cables 15, 15′ leave the interior space 10 of the front handle 6 at the end 20 of the handle 6. The connecting cables 15, 15′ run from the end 20 of the front handle 6 along the housing 2 of the work apparatus to the first electrical functional element 13. As already described above, the at least one connecting cable 15 is connected to the first electrical functional element 13 via a switch 24. The connecting cables 15, 15′ are held on the housing 2 of the work apparatus 1 by a plurality of clips 37, 37′, 37″, 37′″.

As shown in FIG. 3, the work apparatus 1 comprises a handle tube insert 17. The handle tube insert 17 is preferably formed from a metal alloy. The handle tube insert 17 serves to fasten the front handle 6 to the housing 2 of the work apparatus 1. The handle tube insert 17 is arranged at the one end 20 of the front handle 6 in the interior space 10 of the front handle 6. The handle tube insert 17 comprises a plurality of openings 41, in the preferred exemplary embodiment three openings 41. It can of course be expedient to provide fewer or more than three openings. The front handle 6 also includes openings 42 on its side section 33, which are formed coaxially with the openings 41 of the handle tube insert 17 when the handle tube insert 17 is in the fastened state. The openings 41 of the handle tube insert 17 and the openings 42 of the front handle 6 are designed in such a way that the front handle 6 with the handle tube insert 17 can be fastened to receiving openings of the housing 2 by a plurality of screws 44 projecting through the openings 41, 42. The handle tube insert 17 stabilizes the front handle 6, as a result of which the front handle 6 can be screwed to the housing 2 with a high tightening torque of the screws 44 without being deformed in the process.

As shown in FIG. 3, the handle tube insert 17 comprises a cable channel 18. The cable channel 18 serves to guide the connecting cables 15, 15′. In the exemplary embodiment, the cable channel 18 is designed as a groove on the outside of the handle tube insert 17. It can also be expedient to design the cable channel 18 as a bore through the handle tube insert 17. The cable channel 18 extends from an upper end 45 of the handle tube insert 17 to a lower end 46 of the handle tube insert 17. The handle tube insert 17 extends in its longitudinal direction 47 from the upper end 45 to the lower end 46. The longitudinal direction 47 of the handle tube insert 17 corresponds to the insertion direction 48 of the handle tube insert 17 into the front handle 6. A cable fixation 19 for clamping the connecting cables 15, 15′ is formed on the lower end 46 of the handle tube insert 17 on the handle tube insert 17. The cable fixation 19 is formed from a further cable channel 49 which connects to the cable channel 18. The further cable channel 49 is formed obliquely with respect to the cable channel 18 of the handle tube insert 17. In an axial viewing direction of the screws 43 onto the handle tube insert 17 fastened to the front handle 6, the longitudinal axes of the cable channel 18 of the handle tube insert 17 and of the further cable channel 49 of the handle tube insert 17 enclose an angle α, wherein the angle α is in a range between 70° and 140°, in particular in a range between 90° and 130°. Several lugs 50 are formed on the further cable channel 49. The lugs 50 are arranged alternately on opposite sides of the further cable channel 49 and project at least partially into the further cable channel 49. The connecting cables 15, 15′ are held clamped in the further cable channel 49 by the oppositely arranged lugs 50.

The hand-guided work apparatus 1 preferably comprises at least one contact point for connecting the second electrical functional element 14 to the at least one connecting cable 15, 15′. The contact point is preferably formed in the vicinity of the opening 8. The contact point is preferably provided on the connecting section 35 of the front handle 6. The contact point is preferably provided on a side of the connecting section 35 of the front handle 6 facing the housing 2. The contact point is preferably designed as a soldered connection in order to keep an exposed cable length of the at least one connecting cable 15, 15′ as short as possible. The exposed cable length is the section of the at least one connecting cable 15, 15′ which is arranged on the outside 12 of the front handle 6. Furthermore, the at least one connecting cable 15, 15′ has a concealed cable length which corresponds to the length of the connecting cable 15, 15′ from the opening 8 to the end 20 of the front handle 6. The exposed cable length corresponds to at most 20%, in particular at most 15%, preferably at most 10%, of the concealed cable length of the at least one connecting cable. The exposed cable length corresponds to at most 20%, in particular at most 15%, preferably at most 10% of a distance a between the opening 8 and the end 20 of the front handle 6. The exposed cable length of the at least one connecting cable 15, 15′ is less than 40 mm, in particular less than 30 mm. The exposed cable length is preferably about 25 mm. The concealed cable length of the at least one connecting cable 15, 15′ is in a range between preferably 175 mm and 325 mm, in particular between 205 mm and 275 mm. The concealed cable length of the at least one connecting cable 15, 15′ is approximately 235 mm.

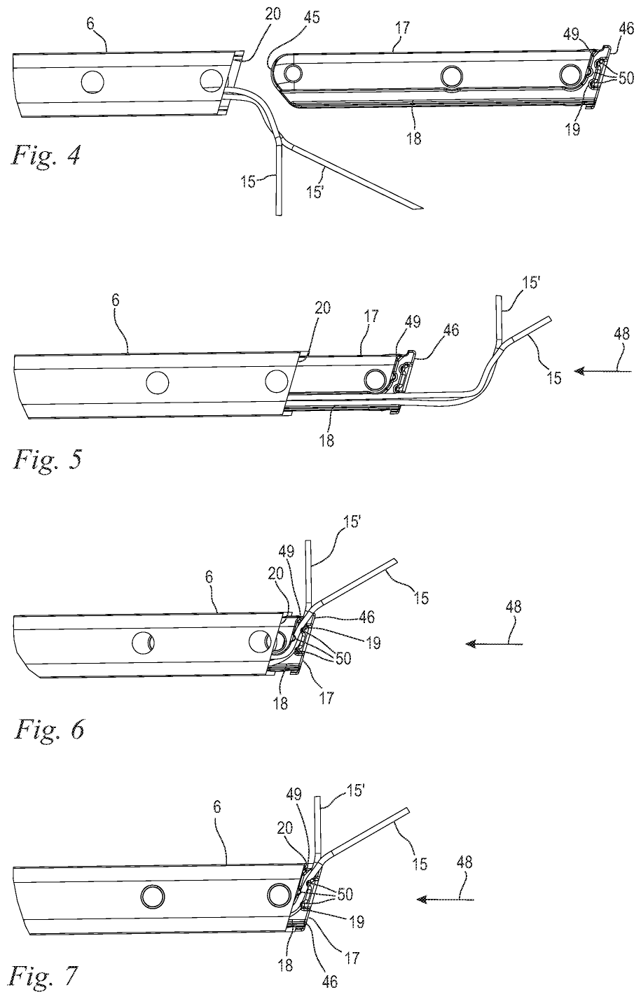

FIGS. 4 to 7 show the individual steps for assembling the handle tube insert 17 on the front handle 6. FIG. 4 shows the end 20 of the front handle 6, wherein the connecting cables 15, 15′ project from the end 20 of the front handle 6. The handle tube insert 17 is located outside the front handle 6. The connecting cables 15, 15′ are inserted into the cable channel 18. Subsequently, the handle tube insert 17 is pushed into the interior space 10 of the front handle 6 in the insertion direction 48, as shown in FIG. 5. The connecting cables 15, 15′ are guided through the cable channel 18 of the handle tube insert 17. Even before the handle tube insert 17 is pushed into the front handle 6 until it stops, the connecting cables 15, 15′ can be clamped into the further cable channel 49 via the lugs 50 (FIG. 6). Subsequently, the handle tube insert 17 can be pushed into the front handle 6 up to a stop.

What is claimed is:

1. A hand-carried work apparatus, comprising:
a housing (2), wherein the housing (2) has
a top side (26),
a bottom side (27),
two longitudinal sides (28, 29), including
a first longitudinal side (28), and
a second longitudinal side (29),
wherein the top side (26) and the bottom side (27) are connected to one another via the two longitudinal sides (28, 29);
a drive motor (3) arranged in the housing (2), wherein the drive motor (3) drives a tool (5) arranged at a front end (30) of the housing (2);
a front handle (6); and
a rear handle (36),
wherein the front handle (6) is a handlebar and has a transverse section (32) extending along the top side (26) of the housing (2) and a side section (33) extending along one of the two longitudinal sides (28, 29) of the housing (2),
wherein the front handle (6) has a wall (7) and an interior space (10) enclosed by the wall (7),
wherein the wall (7) of the front handle (6) comprises an inside (11) facing the interior space (10) and an outside (12) facing away from the interior space (10),
wherein a first electrical functional element (13) is arranged in the housing (2),
wherein a second electrical functional element (14) is arranged on the outside (12) of the front handle (6),
wherein the first electrical functional element (13) is connected to the second electrical functional element (14) via at least one connecting cable (15), and
wherein the at least one connecting cable (15) is arranged at least partially in the interior space (10) of the front handle (6) in an area of the side section (33) of the front handle (6).

2. The hand-carried work apparatus according to claim 1,
wherein the second electrical functional element (14) is a heating foil.

3. The hand-carried work apparatus according to claim 1,
wherein the second electrical functional element (14) is a sensor.

4. The hand-carried work apparatus according to claim 1,
wherein the first electrical functional element (13) is an energy source for supplying the second electrical functional element (14) with electrical current.

5. The hand-carried work apparatus according to claim 3,
wherein the first electrical functional element (13) is a control unit for processing data signals.

6. The hand-carried work apparatus according to claim 1,
wherein an opening (8) is provided on the wall (7) of the front handle (6) to the second electrical functional element (14),
wherein the opening (8) extends from the outside (12) of the wall (7) to the inside (11) of the wall (7),
wherein the at least one connecting cable (15) runs from the outside (12) of the wall (7) through the opening (8) into the interior space (10) of the front handle (6).

7. The hand-carried work apparatus according to claim 6,
wherein the opening (8) is provided with a grommet (9) as edge protection.

8. The hand-carried work apparatus according to claim 6,
wherein the front handle (6) has an approximately horizontally extending holding section (16), and
wherein the opening (8) of the wall (7) is provided outside the holding section (16).

9. The hand-carried work apparatus according to claim 6,
wherein the transverse section (32) and the side section (33) of the front handle (6) are connected to one another via a curved connecting section (35), and
wherein the opening (8) is provided in the side section (33) adjacent to the connecting section (35).

10. The hand-carried work apparatus according to claim 1,
wherein the handle (6) is made of aluminum or plastic.

11. The hand-carried work apparatus according to claim 1,
wherein the work apparatus (1) comprises a handle tube insert (17) for fastening the front handle (6) to the housing (2) of the work apparatus (1), and
wherein the handle tube insert (17) is arranged in the interior space (10) of the handle (6) at one end (20) of the front handle (6).

12. The hand-carried work apparatus according to claim 11,
wherein the handle tube insert (17) has a cable channel (18) for guiding the at least one connecting cable (15).

13. The hand-carried work apparatus according to claim 11,
wherein the handle tube insert (17) has a cable fixation (19) for clamping the at least one connecting cable (15).

14. The hand-carried work apparatus according to claim 13,
wherein the connecting cable (15) runs from the outside (12) of the wall (7) of the front handle (6) via the interior space (10) of the front handle (6) through a cable channel (18) of the handle tube insert (17) to the one end (20) of the front handle (6).
